(19) United States
(12) Patent Application Publication
(10) Pub. No.: US 2013/0199209 A1
(43) Pub. Date: Aug. 8, 2013

(54) METHOD FOR CONTROLLED TEMPERATURE CHANGE OF SUBSTANCES

(71) Applicants: Henno Hensen, Bremen (DE); Harald Saelens, Marke (BE)

(72) Inventors: Henno Hensen, Bremen (DE); Harald Saelens, Marke (BE)

(73) Assignee: SCALDOPACK SPRL., Dottignies (BE)

(21) Appl. No.: 13/822,585

(22) PCT Filed: Sep. 14, 2011
(86) PCT No.: PCT/EP11/65951

§ 371 Date: Mar. 26, 2013

(30) Foreign Application Priority Data
Sep. 14, 2010 (DE) 10 2010 045 261.0

(51) Int. Cl. F25D 5/00; C09K 5/18; F24J 1/00

(52) U.S. Cl. CPC F25D 5/00; F24J 1/00; C09K 5/18
USPC 62/4; 126/263.01; 126/263.05

(57) ABSTRACT

A method for controlled temperature change of substances, in which the course of an endo- or exothermic reaction of one or several reactants in aqueous solution, which is in direct or indirect contact with the substances, is influenced using galenic methods is disclosed. At least one of the reactants is present in a solid form and is at least partly included in a galenic matrix. The galenic matrix is at least partly in a form such as tablets, granules, prills, pellets, rods or combinations thereof. The galenic matrix is differently strongly pressed and/or agglomerated in at least one of different regions and different parts. Also disclosed is a galenic matrix containing at least one solid reactant and methods of using such a galenic matrix.

### TECHNICAL FIELD

The invention relates to a method for controlled temperature change of substances, wherein the course of reaction of an endo- or exothermic reaction of one or several reactants in aqueous solution, which is in direct or indirect contact with the substances, is influenced using galenic methods and to a galenic matrix, which influences the reaction behavior of reactants.

### BACKGROUND OF THE INVENTION

For heating or cooling of packaged goods in the cosmetics, medical or food sector without external energy supply, chemicals separately integrated into the packaging are used, which react upon contact with one another. Such goods normally are solid or liquid substances, for example beverages. Depending on the starting materials used, such reactions may be highly exothermic and emit heat. In this case, the reaction results in heating of the packaging and the substances contained therein. Contrary to that, endothermic reactions extract energy from the environment and thus result in cooling of the packaging and the substances contained therein. Packaging or packaged goods, respectively, of the type described above are known, for example, from U.S. Pat. No. 6,484,514 B1.

It is disadvantageous, that such reactions often happen very quickly and the reactants are consumed within a short time.

In this manner, the substances may, for example, be heated very quickly, however, they are then not kept warm over a longer period of time.

Additionally, in exothermic reactions, quite high peak temperatures of more than 100° C. may occur. Depending on the application, the high peak temperature may also be disadvantageous, since the substance to be heated or the packaging could be damaged. Temperatures of more than 100° C. effect strong evaporation of aqueous solutions, which results in an increase in pressure inside the packaging. This increase in pressure may cause the packaging to burst/explode, like described, for example, on the Internet on the following website: http://www.lanceandeskimo.com/chefelf/bev_hillsidecoffee.shtml. If the substance to be heated is a beverage, then such a high temperature may furthermore result in scalding of the consumer.

A known method for slow heating or cooling is the use of so-called phase change materials. Such phase change materials utilize the enthalpy of reversible thermodynamic changes of state of a storage medium, like for example the solid-liquid phase transition (solidifying/melting). Disadvantages are the relatively high costs of the phase change materials, like described, for example, on the Internet pages http://en.wikipedia.org/wiki/Phase_change_material and http://de.wikipedia.org/wiki/Latentw%C3%A4rmespeicher. Thus, these materials are profitable with multiple application only, with a preceding return into the original thermodynamic condition. This is not reasonable for the use of single-use or disposable packaging. Furthermore, high quantities of required phase materials are disadvantageous. Depending on the application, the 1- to 2-fold of the mass of the goods is required in phase material. This results in massive packaging and additionally in high costs.

### Objective

The objective the invention is based on is to change the temperature of one or several substances long-lastingly in a manner as simple as possible.

### Invention

According to a first teaching of the invention, in a method for controlled temperature change of substances, the objective is solved by the fact that the course of reaction of an endo- or exothermic reaction of one or several reactants in aqueous solution, which is in direct or indirect contact with the substances, is influenced using galenic methods, wherein at least one of said reactants is present in a solid form and is at least partly comprised in a galenic matrix (a composition), and wherein said composition is at least partly in a form selected from the group consisting of tablets, granules, prills, pellets, rods, and any combination thereof, and wherein said composition is differently strongly pressed and/or agglomerated in at least one of different regions and different parts.

Furthermore, according to a second teaching of the invention, for a galenic matrix, the objective is solved by the fact that said galenic matrix comprises at least one solid reactant and that said composition is in a form selected from the group consisting of tablets, granules, prills, pellets, rods, and any combination thereof, and that said composition comprises solid reactant is differently strongly pressed and/or agglomerated in at least one of different regions and different.

Finally, the objective is solved by the use of a galenic matrix, in particular a galenic matrix as described above, for controlled temperature change of substances.

Advantageous in the invention is that the maximum energy released by the exothermic reaction or absorbed by the endothermic reaction can be determined as required from starting materials and ambient conditions by the application of the method within the limits specified by the system. Therewith, concrete target temperatures can be set. In this manner, beverages can be maintained at a temperature particularly suitable for consumption over a longer period of time.

It is furthermore advantageous that using the galenic methods the reaction rate and the duration of a chemical reaction may be set independent from the starting materials. Thus, a certain cooling or heating rate as well as the duration of cooling or heating can be set. Ideally, the target temperature may even be maintained in a constant temperature range over a relatively long period of time, in case of heating in particular in the range from 40 to 80° C., preferably in the range from 55 to 75° C., particularly preferred in the range from 55 to 75° C. In case of cooling, the constant temperature range is in particular in the range from 0 to 20° C., preferably from 2 to 15° C., particularly preferred from 4 to 10° C.

In terms of the invention, a galenic matrix shall mean a composition of substances. In this composition of substances the reaction behavior of a reactant is influenced by the degree of solubility of the reactant the availability of the reactant to water and/or the amount of heat energy provided to the reactant, similar as the drug release is influenced in pharmaceutics. This may, for example, be achieved by a reduction of or increase in the solubility of the reactant by integration into the matrix. Furthermore, components comprised in the galenic matrix may accelerate or decelerate the reaction of the reactant by adding heat, for example from solution energy, or by absorption. Coating the reactant with a water-soluble, unreactive substance, a delay in the start of reaction, for example, may be achieved.

Galenic methods shall mean methods, which correspond to methods of pharmaceutical formulation of drugs and are similar to these methods. This means methods of adjusting (setting) the solubility of the reactant in water, of adjusting (setting) the water availability for the reactant and or of adjusting (setting) the provision of heat energy. Similar as in pharmaceutical formulation the drug release of the medicament is optimized, using the galenic methods according to the invention, the reaction behavior of one or several reactants is influenced for a certain purpose. This may be achieved by integration into a galenic matrix. Furthermore, the reaction may be influenced by a change of the medium, where it takes place in, for example reduction of the reaction rate by reducing the diffusion in a solution.

A composition according to the invention comprises one or more substances.

The substance/s to be heated may be gaseous, solid or liquid. In particular, heating or cooling of solid and/or liquid substances is concerned.

Reactants are the starting materials of a chemical reaction. The reactants may be present in a solid, liquid or gaseous phase.

Unless stated otherwise, concentration data (percentages, portions) in the following provide the mass of a material relative to the total mass of the phase, which the material is in. If, for example, a solid and a liquid phase exist, then the portions (percentages) of the materials in the solid phase add up to 100% as well as the portions (percentages) of the materials in the liquid phase add up to 100%.

Prior to being contacted with one another, the different phases, for example the solid and the liquid phase, may be present physically separated from one another. This may, for example, be realized by the fact that one phase is located in an inner container, e.g. a sachet, which together with the second phase is located in an outer container, e.g. a further sachet. Preferably, a solid phase is located in the inner and a liquid phase also in the inner container but divided by a frangible film, or a solid phase is located in the inner and a liquid phase in the outer container. Applying force, the inner bag may be destroyed, and thus the phases physically separated from one another are contacted. The different phases may, as said before, also be present in a container separated by a separating wall. Destroying the separating wall, for example by applying force, brings the separated phases in contact.

According to one embodiment of the method, the composition comprising the solid reactant is present as, tablet, granules, pellet, prill, or stick.

Tablets, pellets and rods of the composition may be manufactured using a known method by compressing a powder. Further suitable compacting methods are pressure and force compacting or tableting.

For example tablets can be pressed with the pressing machine Fette 1200i, which is commercially available. Information about the machine can be found at http://www.fette-compacting.com/data content/1200i_eng.pdf. In this machine tablets may be pressed using 13 mm flat surface bevel edge tools. Thus, the produced tablets have a diameter of 13 mm and accordingly a top (and bottom) surface of 1,32665 cm².

The pressing strengths used with the pressing machine are in the range of 4 to 80 kN, preferably in the range of 15 to 60 kN, more preferably in the range of 18 to 38 kN. The differences in pressing strength are in the range of 1 to 60 kN, preferably 5 to 35 kN, more preferably in the range of 10 to 20 kN.

Thus, tablets are pressed with a pressing strength based on the pressing area in the range of 3 to 60 kN/cm², preferably in the range of 11 to 45 kN/cm², more preferably in the range of 14 to 29 kN/cm². Also prills, pellets and rods may be pressed with such a pressing strength.

The tablets according to the invention can have any known tablet shape. The base area of the tablet can, for example be circular, oval, triangle shaped, rectangular, squared. The surfaces of the tablets may, for example, be flat faced, bevel-edged flat faced or round shaped. The shape of the tablet can be oblong with rounded or non-rounded surfaces. Round shaped surfaces are preferred. Tablets with round shaped surfaces have the advantage of a minimal contact area between two tablets. The minimal contact area of two tablets ensures that the majority of the tablet surfaces are available for contact with the aqueous solution. The tablets according to the invention may have indentations. Indentations lead to an in crease in accessible surface of the tablet. Indentations allow water to better access the entire surface of the tablet, especially when the tablets are stacked one on top of the other. This stacking of tablets often occurs when the tablets are densely packed into the reaction chamber. The solubility controlling additives to reduce the speed and increase the speed are also added to the tablets.

Granules of the composition may, for example, be obtained by dry or wet grinding of a previously compressed form of the solid reactant or by roller granulation. In the granulation of the reactant granulation additives may be added. An example of a granulation additive is Polyethylenglycol (PEG). The granulation additives have a high impact on the solubility of the granules. The size of the granules may be increased by granulation through compacting, powder granulation or granulation through mixing with or without chopper and/or intensifier bar.

A prill is a small aggregate of a material, most often a dry sphere, formed from a melted liquid. The material to be prilled must be a solid at room temperature and a low viscosity liquid when melted. Prills are formed by allowing drops of the melted prill substance to congeal or freeze in mid-air after being dripped from the top of a tall prilling tower. For example, prills can be obtained for example by high sheer mixing.

The packing density of the solid reactant achieved by compression or agglomeration has an influence on the rate of reaction between the solid reactant and further reactants. In that, higher density, obtained by stronger compression or agglomeration, results in a higher reduction of the reaction rate.

The composition comprising the solid reactant may be compressed or agglomerated to a different degree in different regions. Therewith, tablets, granules, prills, rods or pellets are obtained, which consist of regions with different densities and breaking strengths. Similarly, different agglomeration strengths may be used in the generation of the granules and prills. Different agglomeration strengths lead to significantly different breaking strengths and packing densities of individual granules or prills.

Differently pressed or agglomerated means according to the invention that the compared object are both at pressed with a minimal force.

Further, granules with different agglomeration strengths may be produced by granulating or powder or tablets with regions of different pressing strengths. On the other hand tablets with different pressing strengths may be produced by pressing granules of different densities and pressing strengths and a powder together to form a tablet.

A further method to produce a tablet with differently compressed regions is that one tablet is pressed medium-hard and a second one is pressed very strong. Both tablets are then granulated creating a first phase with soft granules and a second phase with strong granules. These different granules are then pressed to produce tablets from the granules.

These differently compressed regions react at different rates. For example, the tablets, granules, prills, rods or pellets can consist of a fast-reacting region, a medium-fast reacting region and a slow-reacting region. However, embodiments of the tablets, the granules, the prills, the rods and the pellets with more than 2, preferably more than 3, particularly preferred more than 5, and in particular up to 8 different regions are possible, too.

The body formed by the solid reactant, for example tablet, granules, prills, pellet, or rod may be stronger compressed or agglomerated on the inside than on the outside. Thus, the body comprises of a strongly compressed core and one or more layers with a decreasing density surrounding this core. Or for tablet different layers going from a high density to low density compressed layer. Furthermore, upon using several tablets, rods or pellets, the pressing may vary from one tablet, rod or pellet to the other. Likewise in a set of granules or prills the agglomeration strength may differ from one individual granule or prill to another.

According to a further embodiment of the method of to the invention, the differently strongly pressed or agglomerated reactants or additives are combined in one multiphase tablet, rod, pellet, granulate or prill.

According to a further embodiment of the method the composition comprising the solid reactant is coated. The whole composition formed to a tablet, rod, pellet, prill or granule formed by the composition can be coated. Alternatively, particles of the reactant within the composition can be individually coated. Preferably, the coated layer is water-soluble. Such a water-soluble layer is used to prevent the reactant enclosed by the layer from reacting prematurely already.

Furthermore, a water-soluble layer surrounding the solid reactant enables a delay of the start of reaction. The delay depends on the type and thickness of the water-soluble layer.

Examples for materials, which may be used as the water-soluble layer, are natural water-soluble polymers, inorganic water-soluble polymers, synthetic water-soluble polymers, semi-synthetic water-soluble polymers, polymers of plant origin, polymers of micro-organismic origin, polymers of animal origin, starch polymers, cellulose polymers, alginate polymers, vinyl polymers, polyoxyethylene polymers, acrylate polymers, cetyl palmitates, natracol-β-carotene, cetyl alcohol, bolus, hypromellose as well as further materials used in the area of coating.

In a further embodiment of the method of the invention, the composition comprises an anticaking agent. An anticaking agent is an additive placed in powdered or granulated materials to prevent the formation of lumps, easing packaging, transport, and consumption. The examples given as materials for the water soluble layer can also be used as anti-caking agents.

Several of the water-impeding substances can be used as anticaking agents. One example is of a water-impeding substance commonly used as a lubricant (anticaking agent) is calcium stearate. Calcium stearate is almost insoluble in water thus working as a water impeding substance but at the same time it serves as an anti-caking agent. Other examples are PEG, which depending on the length of the carbon chain dissolves slowly in water, magnesium stearate, calcium hydrogen phosphate, and calcium carbonate.

According to yet another embodiment of the method of the invention, the composition comprises one or several water-impeding substances in addition to the solid reactant. In the present invention, water-impeding substances shall in particular mean such substances, the solution rate of which is below the water absorption rate of the solid reactant and which thereby delay the contact of the solid reactant with the water or the reactants dissolved in the water. Furthermore, water-impeding substances may be such ones, which react with the water themselves. Water impeding substances may absorb to the surface of reactant particles.

Examples for water-impeding substances are citric acid or other solid acids, which are easily dissolved in water, preferably in a concentration from 0 to 30%. Particularly preferred is citric acid, since this acid shows the strongest water-impeding effect.

Further examples for water-impeding substances are hydrated or dry calcium hydrogen phosphate, preferably in a concentration from 10 to 40%, calcium carbonate, preferably in a concentration from 10 to 40%, Povidon®, preferably in a concentration from 0 to 50%, polyvinylpyrrolidone, preferably in a concentration from 0 to 50%, sorbitol, preferably in a concentration from 1 to 20%, mannitol, preferably in a concentration from 1 to 20%, lactose, preferably in a concentration from 1 to 20%, gelatin, preferably in a concentration from 1 to 25%, sodium sulfate, preferably in a concentration from 1 to 30%, p-toluene sulfonic acid, preferably in a concentration from 0 to 25%, trichloroacetic acid, preferably in a concentration from 0 to 25%, titanium oxide, preferably in a concentration from 0 to 25%, compressible sugar, preferably in a concentration from 1 to 20%, malic acid, preferably in a concentration from 0 to 25%, maleic acid, preferably in a concentration from 0 to 25%, maleic acid anhydride, preferably in a concentration from 0 to 25%, benzoic acid, preferably in a concentration from 0 to 20%, metal stearate, in particular selected from a group comprising magnesium stearate, sodium stearate and calcium stearate, preferably in a concentration from 2 to 20%, lauric acid, preferably in a concentration from 0 to 5%, sodium lauryl sulfate (SLS), preferably in a concentration from 0 to 5%, salicylic acid, preferably in a concentration from 1 to 25%, acetyl salicylic acid, preferably in a concentration from 1 to 25%, hydrated oil, preferably in a concentration from 5 to 30%, NOCOLOK®, preferably in a concentration from 0 to 30%, calcium silicate, preferably in a concentration from 0 to 35%, cholestyramine resin, preferably in a concentration from 5 to 50%, sodium polystyrene sulfonate, preferably in a concentration from 5 to 75%, glycerol, preferably in a concentration from 0 to 20%, and cross-linked polyvinylpyrrolidone, preferably in a concentration from 1 to 10%. Due to its particularly good water-impeding characteristics, magnesium stearate is particularly preferred.

Further examples of water impeding substances are stearic acid, preferably in a concentration from 1 to 20%, aluminium stearate, preferably in a concentration from 1 to 20%, aluminium-di-tri-stearate, preferably in a concentration from 1 to 20%, aluminium-di-stearate, preferably in a concentration from 1 to 20%, aluminium-mono-di-stearate, preferably in a concentration from 1 to 20%, lead stearate, preferably in a concentration from 1 to 20%, calcium-12-oxystearate, preferably in a concentration from 1 to 20%, calcium laurate, preferably in a concentration from 1 to 20%, calcium behenate calcium, preferably in a concentration from 1 to 20%, zinc stearate, preferably in a concentration from 1 to 20%, zinc laurate, preferably in a concentration from 1 to 20%, zinc oleate, preferably in a concentration from 1 to 20%, barium stearate, preferably in a concentration from 1 to 20%, barium-12-oxystearat (barium salt of a 12-hydroxy-stearic acid), preferably in a concentration from 1 to 20%, barium laurate, preferably in a concentration from 1 to 20%, lithium stearate, preferably in a concentration from 1 to 20%, lithium-12-oxystearate 1 to 20%, ammonium stearate 1 to 20%, sodium stearyl sumarate, preferably in a concentration from 1 to 20%, potassium stearate, preferably in a concentration from 1 to 20%, glyceryl tristearate, preferably in a concentration from 1 to 20%, glyceryl trihydroxystearate, preferably in a concentration from 1 to 20%, glycerol monooleate, preferably in a concentration from 1 to 20%, glycerol monostearate, preferably in a concentration from 1 to 20% glycerol dioleate, preferably in a concentration from 1 to 20%, glyceryl trioleate, preferably in a concentration from 1 to 20%, stearyl stearate, preferably in a concentration from 1 to 20%, stearyl phthalate, preferably in a concentration from 1 to 20%, stearyl behenate, preferably in a concentration from 1 to 20%, diisotridecyl adipate, preferably in a concentration from 1 to 20%, isotridecyl stearate, preferably in a concentration from 1% to 20%, trimethylolpropane trioleate, preferably in a concentration from 1 to 20%, trimethylolpropane tricaprylate/-caprate 1 to 20%, preferably in a concentration from 1 to 20%, pentaerythritol tetrastearate, preferably in a concentration from 1 to 20%, pentaerythritol monooleate, preferably in a concentration from 1 to 20%, neopentyl glycol dioleate, preferably in a concentration from 1 to 20%, polyethyleneglycol monooelate, preferably in a concentration from 1 to 20%.

Moreover, fatty-acids or their salts can be used as water impeding substances. More specific, these are fatty acids with carbon atoms ranging from 4 to 26. The fatty acids and their derivatives may be employed in a percentage of 1% -20%.

Some common examples with their applicable number of carbon atoms are: lauric acid C12, myristic acid C14, palmitic acid C16, stearic acid C18, oleic acid C18 arachidic acid C20, behenic acid C22, lignoceric acid C24 cerotic acid C26.

Examples of salts of fatty acids are salts of lauric acid, preferably in a concentration from 1 to 20%, salts of myristic acid, preferably in a concentration from 1 to 20%, salts of palmitic acid, preferably in a concentration from 1 to 20% salts of stearic acid, preferably in a concentration from 1 to 20%, salts of oleic acid, preferably in a concentration from 1 to 20%, salts of arachidic acid, preferably in a concentration from 1 to 20%, salts of behenic acid, preferably in a concentration from 1 to 20%, lignoceric acid, preferably in a concentration from 1 to 20%, cerotic acid, preferably in a concentration from 1 to 20%.

Further water-impeding substances according to the invention are oils. Examples are tri-acyl glycerol, preferably in a concentration from 1% to 15%, palm-oil, preferably in a concentration from 1% to 15%, corn-oil, preferably in a concentration from 1% to 15%, mineral oil, preferably in a concentration from 1% to 15%.

Water-impeding substances may also act as lubricants for compacting or granulation of the reactant.

Povidon® is also called polyvidone or PVP. It stands for polyvinylpyrrolidone with the elemental formula (C6H9NO)n and with CAS No. 9003-39-8.

NOCOLOK® means a product of the company Solvay, which is also sold under the trade name NOCOLOK® Flux. It stands for potassium fluoroaluminates with the elemental formula K1-3A1F4-6, with CAS No. 60304-36-1 and with the composition K 28-31%, Al 16-18%, F 49-53%, Fe max. 0.03%, Ca max. 0.1%, loss on ignition max. 2.5%.

Furthermore, polyethylene glycol (PEG) with an average molar mass from 80 to 20,000 g/mol (PEG80 to PEG20000), preferably in a concentration from 0 to 20%, may be used. PEGs with an average molar mass of over 600 are preferred. Prerequisite is that the PEG is solid at 20° C. Surprisingly, it showed that magnesium stearate, calcium stearate, hydrogenated oil, polyvinylpyrrolidone, PEG 6000, and PEG 8000 are particularly suited as the water-impeding substances. Magnesium and calcium stearate are stable even at temperatures above 80° C. Hydrogenated oil has similar characteristics and is very cost efficient. Polyvinylpyrrolidone is highly effective as a water-impeding substance and therefore only low concentrations are needed.

The concentrations indicate the mass of the water-impeding substance in percent of the total mass of the solid substance or substances.

According to yet another embodiment of the galenic matrix, beside the reactant present in a solid form, it comprises a phase change material. The phase change material absorbs the excess heat above a certain temperature, preferably between 70 and 110° C., and uses this energy for the phase transition. Upon undercutting the phase change temperatures, the absorbed thermal energy is released again. Examples for phase change materials are polyethylene (PE) and paraffin. PE has, depending on the composition and the quantity of additives added, for example plasticizers, a phase change temperature between 70 and 110° C.

According to yet another embodiment of the method, beside the solid reactant, the composition comprises one or several reaction enhancers. A reaction enhancer according to the invention is a substance that provides energy for the main reaction, the reaction of the reactant. Reaction enhancers can be substances with an exothermic solution enthalpy, which release heat when contacting the solvent, or substances that involve in an exothermic chemical reaction. The reaction enhancers may provide the activation energy for the main reaction. Other reaction enhancers may enhance the reaction by increasing the solubility and consequently the access of water to the reactant to ensure a homogenous reaction and an increase in reaction speed.

Such reaction enhancers on the one hand serve to homogenize the rate of reaction. For example, upon using several tablets, using such reaction enhancers, a uniform start of reaction may be guaranteed. On the other hand, reaction enhancers are also required in order to start the reaction, when due to other additives the reaction rate was reduced too much.

Reaction enhancers according to the invention, which provide for faster dissolution of the solid reactant, are microcrystalline cellulose (MCC), preferably in a concentration from 5 to 50%, sodium carboxyl methylcellulose, preferably in a concentration from 0 to 50%, sodium starch glycolate, preferably in a concentration from 0 to 8%, croscarmellose sodium, preferably in a concentration from 1 to 3%, soya polysaccharides, preferably in a concentration from 1 to 4%, sodium stearyl fumarate, preferably in a concentration from 0.1 to 20%, alginic acid, preferably in a concentration from 5 to 8%, sodium polystyrene sulfonate, preferably in a concentration from 0 to 20%, and polacrilin potassium, preferably in a concentration from 0 to 2%, magnesium stearate, preferably in a concentration from 0 to 2%, calcium chloride, preferably in a concentration from 1 to 40%, titanium oxide, preferably in a concentration from 1 to 45%, stearic acid, preferably in a concentration from 0 to 10%, sodium stearate, preferably in a concentration from 0 to 2%, calcium stearate, preferably in a concentration from 0 to 2%, sodium benzoate, preferably in a concentration from 0 to 2%, glycerol palmitostearate, preferably in a concentration from 2 to 5%, glycerol behenate, preferably in a concentration from 2 to 5%, talc, preferably in a concentration from 1 to 10%, and pyrogenic silicon dioxide, preferably in a concentration from 0.1 to 2%. Surprisingly, it was found that calcium chloride, magnesium chloride, micro-crystalline cellulose (MCC), and sodium carboxyl methylcellulose in the solid phase are particularly suited as the reaction enhancer. Calcium Chloride is readily available and nontoxic, which is important if food or beverages are to be heated or cooled. Furthermore, it is cheaper than other reaction enhancers. Magnesium chloride has a strong reaction enhancing effect and, thus, can be used in low concentrations to reduce total volume of the formulation. Magnesium chloride is also non toxic. MMC is particularly suited for its extraordinary capacity of guiding water to the inside of the tablet and evenly distributing the water. This guarantees a homogeneous reaction. Sodium carboxyl methylcellulose advantageously leads quickly to a break of a tablet so that the active ingredients get in contact with the water faster.

Furthermore, salts with a negative (exothermic) enthalpy of solution, in particular in the range from 5 to 100 kcal mol⁻¹, may be used as reaction enhancers in the galenic matrix together with the solid reactant. Magnesium chloride, for example, has an enthalpy of solution of 36.3 kcal mol⁻¹ (Perry's Chemical Engineers, 8th Edition, Table 2-182). Upon dissolution in water, these salts release energy in the form of heat and are therefore particularly suited for initiating the reaction.

According to one embodiment of the method, a substance is heated by an exothermic reaction controlled by galenic methods. In that, an alkaline earth metal oxide is contacted with an aqueous solution. The alkaline earth metal oxide, for example calcium oxide, reacts with the water to calcium hydroxide (Ca(OH)₂) as soon as the contact is established. This reaction is highly exothermic, and it causes temperatures of up to 180° C. Preferably used are calcium oxide, magnesium oxide, strontium oxide, and barium oxide, particularly preferred calcium oxide. The heat resulting from the reaction results in heating of the substances in indirect contact with the aqueous solution, for example food, in particular a warm beverage.

Indirect shall mean that the substances are separated from the aqueous solution by a film, for example a plastic film, metalized film or metal foil.

Advantageous for the reaction of alkaline earth oxides with water are the high energy yield and the spontaneous course of reaction. The capacity of thermal production may still be increased or reduced by addition of various other oxides, for example aluminum chloride, phosphorous pentoxide, magnesium oxide, aluminum oxide, aluminum powder, aluminum hydroxide and/or iron chloride.

According to a further embodiment of the method, the aqueous solution comprises at least one viscosity-increasing substance. Increased viscosity in the aqueous solution results in a reduction of diffusion in the solution. Therewith, the reaction rate between the solid reactant and the dissolved reactant and/or the water is reduced, too. Preferably, this viscosity-increasing substance is glycerol and/or polyethylene glycol (PEG).

The concentration of the glycerol in weight percent relative to the total mass of the aqueous solution is in particular in the range from 0 to 60%. Preferably, the concentration of the glycerol is in the range from 0 to 30%, and particularly preferred from 0 to 10%. The concentration of the PEG in weight percent relative to the total mass of the aqueous solution is in particular in the range from 0 to 30%. Preferably, the concentration of the PEG is in the range from 0 to 15%, and particularly preferred from 0 to 10%. PEG with an average molar mass of 80 to 20,000 g/mol (PEG 80 to PEG 20000), is preferably used in a concentration from 0 to 20%. PEG and glycerol may be used together as well as individually as viscosity-increasing substances.

In addition, the aqueous solution may also comprise one or several further viscosity-increasing substances. As additional viscosity-increasing substances, xanthan, preferably in a concentration from 0 to 2%, guar gum, preferably in a concentration from 0 to 2%, sodium carboxymethyl cellulose, preferably in a concentration from 0 to 2%, Arabic gum, tragacanth, galactan, carob seed gum, karaya, carrageen, pectin, agar, quince seed, algal colloid, starch, glycyrrhizin, dextran, succinoglycan, pullulan, collagen, casein, albumin, gelatin, carboxymethyl starch, methylhydroxypropyl starch, methylcellulose, nitrocellulose, ethylcellulose, methylhydroxypropyl cellulose, hydroxyethyl cellulose, sodium cellulose sulfate, hydroxypropyl cellulose, sodium carboxymethyl cellulose, crystalline cellulose, cellulose powder, sodium alginate, propylene glycol alginate ether, polyvinyl alcohol, poly(vinylmethylether), polyvinylpyrrolidone, carboxyvinyl polymers, acrylic acid and methacrylic acid copolymers, polyoxyethylene and polyoxypropylene copolymers, sodium polyacrylate, polyethylacrylate, polyacrylamide, polyethylenimine, cationic polymers, bentonite, aluminum magnesium silicate, hectorite, silicon anhydride, or combinations of these chemicals may be used. Surprisingly, it was found that xanthan in combination with PEG and glycerol results in a particularly strong increase in viscosity Xanthan, PEG and Glycerol are particularly preferred. Xanthan is non-toxic and has a high impact on the viscosity of a solution. Thus, only low concentrations of xanthan are required. PEG showed an extraordinary good stability and ability to slow down the reaction speed. Glycerol is less effective but cheaper than PEG and therefore a cost efficient alternative to PEG.

According to a further embodiment of the invention, the aqueous solution is an oil-in-water emulsion with a low fat content, i.e. the fat content of the oils used is 0 to 10%, preferably 2 to 8%, particularly preferred 3 to 5%. As the oil, for example corn oil may be used. Such an emulsion has the advantage that the water concentration and therewith the availability of the water molecules as reaction partners is reduced. Stable low-fat emulsions of oils in water may be obtained by adding emulsifying agents, for example lecithin, to the emulsion. Alternatively or in addition to the emulsifying agents, stabilizing agents, like for example modified starch, guar gum or xanthan, may be added. Preferably lecithin alone or in combination with xanthan is used, since herewith particularly stable emulsions may be generated.

In a further embodiment of the method, the aqueous solution comprises a salt, which results in a reduction of the reaction rate. Besides the reduction of the reaction rate, these salts have the further advantages that they lower the freezing point of the solution and increase the boiling point, whereby the risk of strong steam formation is reduced. Examples for suitable salts are sodium chloride, calcium chloride, magnesium chloride, magnesium sulfate and sodium acetate. Preferred concentrations in weight percent relative to the total mass of the aqueous solutions are for sodium chloride 1 to 35%, particularly preferred 5 to 15%, for calcium chloride 5 to 35%, for magnesium chloride 1 to 35%, particularly preferred 5 to 15%, for magnesium sulfate 5 to 40%, and for sodium acetate 5 to 40%. Further examples are aluminum sulfate, preferably in a concentration from 1 to 35%, particularly preferred in a concentration from 5 to 15%, calcium iodide, preferably in a concentration from 1 to 35%, particularly preferred in a concentration from 5 to 15%, calcium sulfate, preferably in a concentration from 1 to 35%, particularly preferred in a concentration from 5 to 15%, iron chloride, FeCl₂-FeCl₃, preferably in a concentration from 1 to 35%, particularly preferred in a concentration from 5 to 15%, iron sulfate, preferably in a concentration from 1 to 35%, particularly preferred in a concentration from 5 to 15%, magnesium iodide, preferably in a concentration from 1 to 35%, particularly preferred in a concentration from 5 to 15%, magnesium sulfate, magnesium phosphate, preferably in a concentration from 1 to 35%, particularly preferred in a concentration from 5 to 15%, magnesium sulfide, preferably in a concentration from 1 to 35%, particularly preferred in a concentration from 5 to 15%, potassium aluminum sulfate, preferably in a concentration from 1 to 35%, particularly preferred in a concentration from 5 to 15%, potassium carbonate, preferably in a concentration from 1 to 35%, particularly preferred in a concentration from 5 to 15%, potassium phosphate, preferably in a concentration from 1 to 35%, particularly preferred in a concentration from 5 to 15%, sodium tetraborate, preferably in a concentration from 1 to 35%, particularly preferred in a concentration from 5 to 15%, sodium carbonate, preferably in a concentration from 1 to 35%, particularly preferred in a concentration from 5 to 15%, sodium phosphate, preferably in a concentration from 1 to 35%, particularly preferred in a concentration from 5 to 15%, disodium phosphite, preferably in a concentration from 1 to 35%, particularly preferred in a concentration from 5 to 15%, sodium sulfide, preferably in a concentration from 1 to 35%, particularly preferred in a concentration from 5 to 15%, tin bromide, preferably in a concentration from 1 to 35%, particularly preferred in a concentration from 5 to 15%, strontium bromide, preferably in a concentration from 1 to 35%, particularly preferred in a concentration from 5 to 15%, strontium chloride, preferably in a concentration from 1 to 35%, particularly preferred in a concentration from 5 to 15%, strontium iodide, preferably in a concentration from 1 to 35%, particularly preferred in a concentration from 5 to 15%, zinc bromide, preferably in a concentration from 1 to 35%, particularly preferred in a concentration from 5 to 15%, zinc chloride, preferably in a concentration from 1 to 35%, particularly preferred in a concentration from 5 to 15%, zinc iodide, preferably in a concentration from 1 to 35%, particularly preferred in a concentration from 5 to 15%, zinc sulfate, preferably in a concentration from 1 to 35%, particularly preferred in a concentration from 5 to 15%.

Surprisingly, it showed that calcium chloride, magnesium chloride and sodium chloride in the solution are particularly suited for reduction of the reaction rate, High concentrations of the metal ion, i.e. calcium, sodium, or magnesium dissolved in the water reduces the solubility of the particular ion and slows down the reaction calcium oxide, sodium oxide, or magnesium oxide with the water.

In a further embodiment of the method, the aqueous solution comprises a sugar and/or a sugar derivative, which results in a reduction of the reaction rate. Examples for suitable sugars or sugar derivatives are saccharose, glucose, lactose, caramel, and maltose. Preferred concentrations in weight percent relative to the total mass of the aqueous solutions for the sugars or sugar derivatives are 0 to 2%.

According to yet another embodiment of the method, the aqueous solution additionally comprises an acid, which forms a poorly soluble salt with the reaction product, the alkaline earth metal ion. One example for such an acid is oxalic acid.

Other acids may be added to the aqueous solution for an increase in the reaction rate. The advantage of these acids is that they shift the reaction equilibrium of the heating reaction (for example CaO+H₂O-->Ca(OH)₂+heat) on the products side and therewith accelerate the reaction. Such acids are, for example, citric acid, preferably in a concentration from 0 to 30%, and acetic acid, preferably in a concentration from 0 to 30%. The concentrations in weight percent are relative to the total mass of the aqueous solutions.

Surprisingly, it has been shown that acetic acid is particularly suited to increase the reaction rate.

Acids or other additives as reaction enhancers are above all advantageous, when, for example, the concentration of glycerol exceeds 10%. With more than 10% glycerol, the reaction cannot be started without rate-increasing additives. The reaction enhancers added to the solid reactant may in this case also be used to start the reaction.

In a further embodiment of the method, the exothermic reaction is subdivided into several temporal phases. This, for example, is possible by dividing the galenic matrix into several parts. The subdivision is advantageous in order to reduce the peak value of the energy released. The peak value of the released energy in each phase corresponds to the peak value of a single-phase reaction divided by the number of phases. In addition, for consecutive reactions and for the same starting quantity of reactants, the duration of the reaction is increased. The reactions of the individual phases may take place simultaneously or consecutively. Between the reactions of the individual phases, there may be a delay period. The time of delay may be adjusted according to the requirements to the substances to be heated.

According to another embodiment of the method, a substance is cooled by an endothermic reaction controlled by galenic methods. The endothermic reaction takes place entropy-driven without the supply of external energy.

According to one embodiment of the method, a carbonate salt and/or bicarbonate salt is contacted with an acid and water. Bicarbonate salt as well as carbonate salt reacts with acid to carbonic acid (H₂CO₃), which in water is in equilibrium with CO₂ and H₂O. The reaction of H₂CO₃ to CO₂ and H₂O is endothermic, thus extracts energy from the environment and thereby effects cooling.

The bicarbonate salt and/or carbonate salt is preferably used in a percentage of 15 to 50%, particularly preferred from 25 to 40%, of the total mass. The acid is preferably used in a portion from 15 to 50%, particularly preferred 25 to 40%. Furthermore, water is preferably used with a portion from 15 to 50%, particularly preferred from 25 to 40%. Particularly preferred is a ratio of (bi)carbonate salt, acid and water of 1:1:1 (33.33%:33.33%:33.33%).

According to a further embodiment of the method, the bicarbonate salt or carbonate salt, respectively, is present in a solid form, while the acid is dissolved in the water. In that, citric acid is particularly preferred as the acid, since citric acid has a positive (endothermic) solution enthalpy and therefore, besides the reaction with the carbonate salt, additionally contributes to cooling in an optimal manner due to its solution in water. For the reaction with the carbonate salt or bicarbonate salt, various acids may be used. Acids with a high Kₐ value (the Kₐ value is the acid dissociation constant and indicates the strength of an acid, i.e. the inclination of the acid to emit protons) and high solubility are preferred. Examples are citric acid, which due to its negative solution enthalpy, its food grade acceptability and its widespread occurrence is particularly preferred, as well as malic acid, fumaric acid, succinic acid, tartaric acid, formic acid, acetic acid, propionic acid, butyric acid, valeric acid, oxalic acid, malonic acid, glutaric acid, adipic acid, glycolic acid, aspartic acid, pimelic acid, maleic acid, phthalic acid, isophthalic acid, terephthalic acid, glutamic acid, lactic acid, hydroxylacrylic acid, a-hydroxy-butyric acid, glyceric acid, tartronic acid, salicylic acid, gallic acid, mandelic acid, tropic acid, ascorbic acid, gluconic acid, cinnamic acid, benzoic acid, phenyacetic acid, nicotinic acid, kainic acid, sorbic acid, pyrrolidone carboxylic acid, trimellitic acid, benzenesulfonic acid, toluenesulfonic acid, sulfaminic acid, ortho-phosphoric acid, pyro-phosphoric acid as well as mixtures of the acids stated above.

According to a further embodiment of the method, cooling is achieved on the basis of the endothermic (positive) solution enthalpy of certain salts and/or other substances. Salts, which may be used for that, are ammonium nitrate, ammonium chloride, potassium chloride, potassium nitrate, copper nitrate, iron nitrate, lithium nitrate, magnesium nitrate, manganese nitrate, quicksilver nitrate, nickel nitrate, silver nitrate, sodium nitrate, strontium nitrate, zinc nitrate, strontium nitrate, zinc nitrate and any other salt with a positive solution enthalpy. Furthermore, urea may be used. Since urea has a highly positive solution enthalpy, it is particularly preferred. Due to the highly positive solution enthalpy, ammonium nitrate, ammonium chloride and potassium nitrate are preferred, in particular in combination with urea.

Preferably, a mixture of urea, potassium nitrate and ammonium chloride is used, which is dissolved in water. The concentration of the urea relative to the total mass including water is in particular 10 to 55%, preferably 20 to 30%, and particularly preferred 25%. The concentration of the potassium nitrate is in particular 5 to 35%, preferably 10 to 20%, and particularly preferred 15%. The concentration of the ammonium chloride is in particular 5 to 40%, preferably 12 to 22%, particularly preferred 17%. The water constitutes the remaining portions. In that, the potassium nitrate may also be replaced or supplemented with one or several other nitrates with the same total nitrate quantity.

The nitrates may be substituted with one another within the quantity ranges stated. The use of two or more nitrates with the same total nitrate quantity has the advantage of a higher solubility of the individual nitrates. If, for example, ammonium nitrate is substituted with potassium nitrate and ammonium nitrate with the same total nitrate quantity, then the concentration of ammonium nitrate is lower and thereby the solubility higher. Furthermore, the substitution of various nitrates may be used to adapt the composition, for example, to the legal specifications valid for food or to reduce the costs.

A further preferred mixture is ammonium nitrate and urea. In that, it is advantageous to use ammonium nitrate in a portion of 15 to 50%, preferably 25 to 40% of the total mass. The urea is in particular used in a portion of 15 to 50%, preferably 25 to 40%. Furthermore, the water is in particular used with a portion of 15 to 50%, preferably 25 to 40%. Particularly preferred is a ratio of ammonium nitrate, urea and water of 1:1:1. In that, the ammonium nitrate may also be substituted with one or several other nitrates with the same total nitrate quantity.

There is a multitude of possibilities to design and further develop the method according to the invention, the galenic matrix according to the invention, and the uses according to the invention. For that, reference is made, on the one hand, to the patent claims subordinate to patent claim 1, and on the other hand, to the description of examples.

All of the following examples also state particularly preferred combinations of the substances usable according to the invention, since, as was surprisingly shown, the substances used in combination harmonize particularly well with one another. In that, the preferred substance combinations shall not be restricted to the concentration data of the examples. Thus, it was demonstrated that, only to give an example, the substance combination of the composition H1 specified in more detail in the following, namely the combination of calcium oxide as a first solid phase with citric acid and calcium oxide as a second solid phase as well as with acetic acid and water as the liquid phase, is particularly suited for the purposes according to the invention. The same shall also apply to the substance combinations of the remaining examples (compositions H2-H7, C1-C7), for which the substances likewise harmonize particularly well with one another.

### EXAMPLES

The following compositions are particularly suited for heating goods:

Composition H1

| | |
|---|---|
| Tablet(s) A (20 g): | 100% calcium oxide |
| Tablet(s) B (25 g): | 30% citric acid |
| | 70% calcium oxide |
| Liquid phase (70 ml): | 25% acetic acid |
| | 75% water |

Tablets A and B were pressed with a Fette 1200i compacting machine, with a 13 mm flat surface bevel edge tool, wherein the pressing strength for tablet(s) A was 25 kN and for tablet(s) B was 38 kN.

Instead of the one or several tablet(s) A and B, pellets, granules, prills, or rods with different pressing strengths may also be used as the solid or solid phase, respectively.

Composition H2

| | |
|---|---|
| Tablet(s) A (20 g): | 100% calcium oxide |
| Tablet(s) B (20 g): | 100% calcium oxide |
| Liquid phase (20 ml): | 1% lecithin |
| | 10% corn oil |
| | 89% water |

Tablets A and B were pressed with a Fette 1200i compacting machine, with a 13 mm flat surface bevel edge tool, wherein the pressing strength for tablet(s) A was 20 kN and for tablet(s) B was 38 kN.

Instead of the one or several tablet(s) A and B, pellets, granules, prills or rods with different pressing strengths may also be used as the solid or solid phase, respectively.

Composition H3

| | |
|---|---|
| Tablet(s) A (15 g): | 100% calcium oxide |
| Tablet(s) B (20 g): | 100% calcium oxide |
| Liquid phase (35 ml): | 0.2% xanthan gum |
| | 5% corn oil |
| | 1% lecithin |
| | 93.8% water |

Tablets A and B were pressed with a Fette 1200i compacting machine, with a 13 mm flat surface bevel edge tool, wherein the pressing strength for tablet(s) A was 18 kN and for tablet(s) B was 36 kN.

Instead of the one or several tablet(s) A and B, pellets, powders, granules, prills, or rods with different pressing strengths may also be used as the solid or solid phase, respectively.

Composition H4

| | |
|---|---|
| Tablet(s) A (15 g) : | 40% CaCl₂ |
| | 60% calcium oxide |
| Tablet(s) B (35 g): | 15% magnesium stearate |
| | 85% calcium oxide |
| Liquid (40 ml): | 100% water |

Tablets A and B were pressed with a Fette 1200i compacting machine, with a 13 mm flat surface bevel edge tool. The pressing strength for tablet(s) A was 25 kN and for tablet(s) B 40 kN.

Instead of the one or several tablet(s) A and/or B, pellets, granules, prills, or rods with different pressing strengths may also be used as the solid or solid phase, respectively.

Composition H5

| | |
|---|---|
| Tablet(s) A (15 g): | 100% calcium oxide |
| Tablet(s) B (20 g): | 100% calcium oxide |
| Liquid (35 ml): | 50% glycerol |
| | 45% water |
| | 5% acetic acid |

Tablets A and B were pressed with a Fette 1200i compacting machine, with a 13 mm flat surface bevel edge tool. The pressing strength for tablet(s) A was 23 kN and for tablet(s) B 36 kN.

Instead of the one or several tablet(s) A and/or B, pellets, granules, prills, or rods with different pressing strengths may also be used as the solid or solid phase, respectively.

Composition H6

| | |
|---|---|
| Tablet(s) A (20 g): | 50% calcium oxide |
| | 50% paraffin (melting point |
| | 70-80° C.) |
| Tablet(s) B (50 g): | 50% calcium oxide |
| | 50% paraffin (melting point |
| | 70-80° C.) |
| Liquid phase (50 ml): | 56% glycerol |
| | 33.5% water |
| | 10.5% acetic acid |

Tablets A and B were pressed with a Fette 1200i compacting machine, with a 13 mm flat surface bevel edge tool. The pressing strength for tablet(s) A was 18 kN and for tablet(s) B 29 kN.

Instead of the one or several tablet(s) A and B, pellets, granules, prills, or rods with different pressing strengths may also be used as the solid or solid phase, respectively.

Composition H7

| | |
|---|---|
| Tablet(s) A (25 g): | 20% calcium chloride |
| | 80% calcium oxide |
| Tablet(s) B (25 g): | 10% PEG 8000 |
| | 90% calcium oxide |
| Liquid phase (40 ml): | 15% calcium chloride 2H₂O |
| | 85% water |

Tablets A and B were pressed with a Fette 1200i compacting machine with standard settings, with a 13 mm flat surface bevel edge tool. The pressing strength for tablet(s) A was 25 kN and for tablet(s) B 40 kN.

Instead of the one or several tablet(s) A and/or B, pellets, granules, prills, or rods with different pressing strengths may also be used as the solid or solid phase, respectively.

The following compositions are particularly suited for cooling:

Composition C1

| | |
|---|---|
| 30 g or 33.33%, resp. | Ammonium bicarbonate |
| | (in the form of granules) |
| 30 g or 33.33%, resp. | Citric acid |
| | (in the form of granules) |
| 30 g or 33.33%, resp. | Water |

The Ammonium bicarbonate was pressed to a tablet with a Fette 1200i compacting machine, with a 13 mm flat surface bevel edge tool with a pressing strength of 20 kN. The tablet was then granulated in a Frewitt 1.5 mm square wire sieve. The citric acid granules were prepared in the same way but with a different pressing strength of 14 kN.

Each solid ingredient of the composition is independently coated with 0.5% calcium stearate based on the weight of the ingredient.

Instead of the granular form, the solids or the respective solid phase, respectively, may also be present as prills, tablets, pellets, or rods with different pressing strengths.

Composition C2 (Comparative Example)
Granules

| | |
|---|---|
| (60 g or 66.66%, resp.) | 49.75% ammonium bicarbonate |
| | 49.75% citric acid |
| | 0.5% PEG 8000 coating |

Liquid phase

| | |
|---|---|
| (30 g or 33.33%, resp.) | Water |

The granules were produced by pressing of the ammonium bicarbonate together with citric acid to a tablet with a Fette 1200i compacting machine at a pressing strength of 20 kN with a 13 mm flat surface bevel edge tool. The tablet was then granulated in a Frewitt 1.5 mm square wire sieve and coated with calcium stearate. The citric acid granules were prepared in the same way.

Instead of the granular form, the solids or the respective solid phase, respectively, may also be present as prills, tablets, pellets, or rods with different pressing strengths.

Composition C3 (Comparative Example)
Granules

| | |
|---|---|
| (60 g or 66.66%, resp.) | 49.75% ammonium bicarbonate |
| | 0.25% PEG 8000 coating |
| | 49.75% citric acid |
| | 0.25% PEG 8000 coating |
| | (Ammonium bicarbonate and |
| | citric acid are present |
| | separated from one another |
| | and are respectively coated |
| | with PEG 8000.) |

Liquid phase

| | |
|---|---|
| (30 g or 33.33%, resp.) | Water |

The ammonium bicarbonate was pressed to a tablet with a Fette 1200i compacting machine at a pressing strength of 20 kN with a 13 mm flat surface bevel edge tool. The tablet was then granulated in a Frewitt 1.5 mm square wire sieve and coated with PEG 8000. The citric acid granules were prepared in the same way.

Instead of the granular form, the solids or the respective solid phase, respectively, may also be present as prills, tablets, pellets, or rods.

Composition C4

| | |
|---|---|
| 30 g or 33.33%, resp. | Ammonium nitrate |
| | (in the form of granules) |
| 30 g or 33.33%, resp. | Urea |
| | (in the form of granules) |
| 30 g or 33.33%, resp. | Water |

Each solid ingredient of the composition is independently coated with 0.5% calcium stearate based on the weight of the ingredient.

The ammonium bicarbonate was pressed to a tablet with a Fette 1200i compacting at a pressing strength of 20 kN with a 13 mm flat surface bevel edge tool. The tablet was then granulated in a Frewitt 1.5 mm square wire sieve and coated with the calcium stearate. The urea granules were prepared in the same way but with a pressing strength of 22 kN.

Instead of the granular form, the solids or the respective solid phase, respectively, may also be present as prills, tablets, pellets, or rods with different pressing strengths.

Composition C5

| | |
|---|---|
| 33% | Ammonium nitrate |
| | (in the form of granules) |
| 33% | Urea |
| | (in the form of granules) |
| 0.7% | Calcium stearate |
| | (in the form of granules) |
| 33.3% | Water |

Each solid ingredient of the composition is independently coated with calcium stearate based on the weight of the ingredient.

The ammonium bicarbonate was pressed to a tablet with a Fette 1200i compacting machine at a pressing strength of 20 kN with a 13 mm flat surface bevel edge tool. The tablet was then granulated in a Frewitt 1.5 mm square wire sieve and coated with the calcium stearate. The urea granules were prepared in the same way but with a pressing strength of 22 kN.

Instead of the granular form, the solids or the respective solid phase, respectively, may also be present as prills, tablets, pellets, or rods with different pressing strengths.

Composition C6

| | |
|---|---|
| 24.5% | Urea |
| | (in the form of granules) |
| 14.3% | Potassium nitrate |
| | (in the form of granules) |
| 16.8% | Ammonium chloride |
| | (in the form of granules) |
| 44.4% | Water |

Each solid ingredient of the composition is independently coated with 0.5% calcium stearate based on the weight of the ingredient.

The urea was pressed to a tablet with a Fette 1200i compacting machine at a pressing strength of 20 kN with a 13 mm flat surface bevel edge tool. The tablet was then granulated in a Frewitt 1.5 mm square wire sieve and coated with the calcium stearate. The potassium nitrate and ammonium chloride granules were prepared in the same way but with a pressing strength of 22 kN and 21 kN, respectively.

Instead of the granular form, the solids or the respective solid phase, respectively, may also be present as prills, tablets, pellets, or rods with different pressing strengths.

Composition C7

| | |
|---|---|
| 24.2% | Urea |
| | (in the form of granules) |
| 14.3% | Potassium nitrate |
| | (in the form of granules) |
| 16.4% | Ammonium chloride |
| | (in the form of granules) |
| 0.7% | Calcium stearate |
| | (in the form of granules) |
| 44.4% | Water |

Each solid ingredient of the composition is independently coated with calcium stearate based on the weight of the ingredient.

The urea was pressed to tablet with a Fette 1200i compacting machine at a pressing strength of 22 kN with a 13 mm flat surface bevel edge tool. The tablet was then granulated in a Frewitt 1.5 mm square wire sieve and coated with the calcium stearate. The potassium nitrate and ammonium chloride granules were prepared in the same way but with a pressing strength of 20 kN and 21 kN, respectively.

Instead of the granular form, the solids or the respective solid phase, respectively, may also be present as prills, tablets, pellets, or rods with different pressing strengths.

In the aforementioned examples the term “tablet(s) A” means that from the type of tablet A there could be provided one or more tablets in this example. This definition also applies, respectively, to the term “tablet(s) B”.

### DRAWING

There is now a plurality of possibilities for embodying and further developing the method according to the invention and the galenic matrix according to the invention. For this, reference is made on the one hand to the claims, which follow claim 1, on the other hand to the description of an exemplary embodiment in connection with the drawing. In the drawing:

FIG. 1 shows a scheme of the method according to the invention,

FIG. 2 shows schematically the different possible forms of the galenic matrix according to the invention,

FIG. 3 shows examples of different pressings or agglomerations of the galenic matrix according to the invention,

FIG. 4 gives an overview of the different ingredients of the galenic matrix according to the invention and

FIG. 5 gives an overview of the different ingredients of the aqueous solution according to the invention.

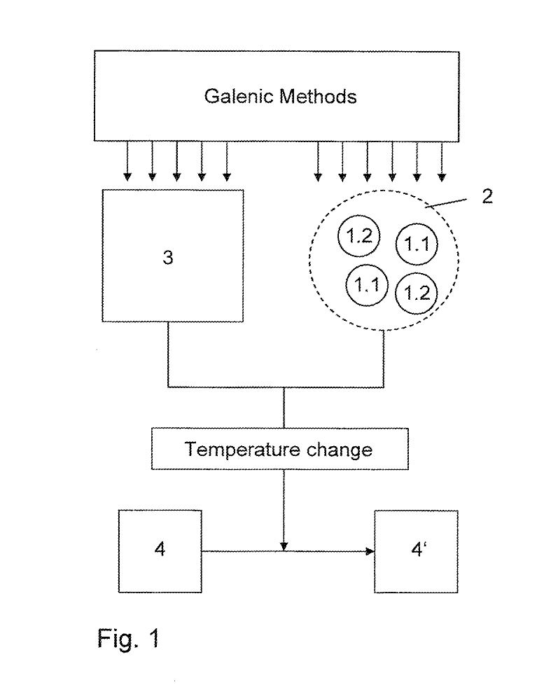

FIG. 1 shows schematically the method according to the invention. In this method for a controlled temperature change of substances 4, 4′, the course of reaction of an endo- or exothermic reaction of one or several reactants 1.1, 1.2 in aqueous solution 3, which is in direct or indirect contact with the substances 4, 4′, is influenced using galenic methods. At least one of said reactants 1.1., 1.2 is present in a solid form and is at least partly comprised in a galenic matrix 2. Due to the exo- or endothermic reaction the substance with a first temperature 4 is heated or cooled to a second temperature 4′.

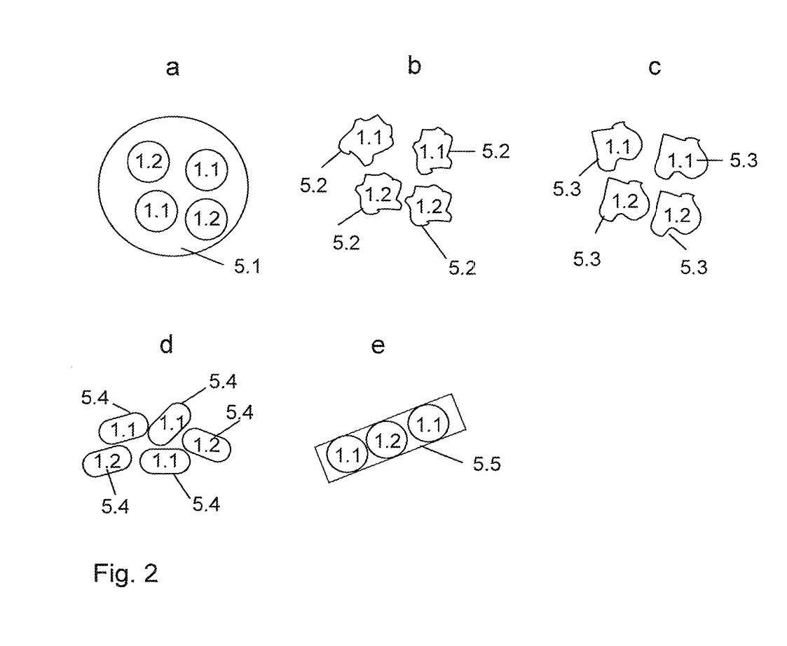

FIG. 2 shows schematically the different possible forms of the galenic matrix 2 comprising a first reactant 1.1 and a second reactant 1.2. The possible forms are a) tablets 5.1, b) granules 5.2, c) prills 5.3, d) pellets 5.4 and e) rods 5.5.

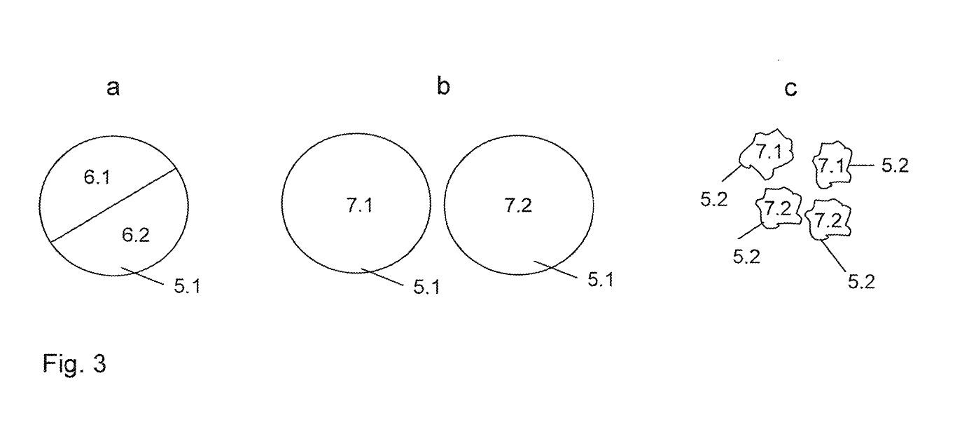

As shown in FIG. 3 the galenic matrix 2 is differently strongly pressed and/or agglomerated in at least one of different regions 6.1, 6.2 and different parts 7.1, 7.2. FIG. 3 a) shows an example of two differently pressed parts. The tablet 5.1 has a stronger pressed region 6.1 and a weaker pressed region 6.2. FIG. 3 b) shows an example of two differently strongly pressed parts. The left tablet 5.1 is the stronger pressed part 7.1 and the right tablet 5.1 the weaker pressed part. FIG. 3 c) shows an example of two differently agglomerated parts. Some of the granules 5.2 are strongly agglomerated 7.1 others granules 5.2 are only weakly agglomerated 7.2.

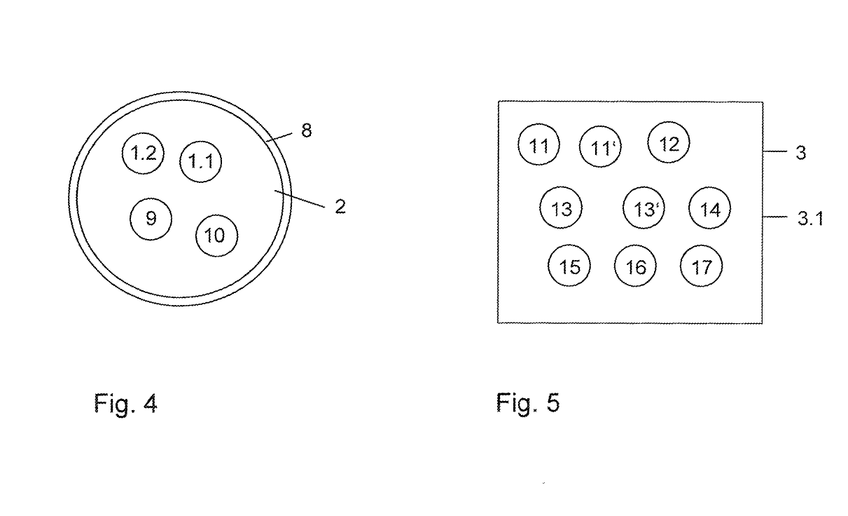

FIG. 4 shows an example of a galenic matrix, that is a composition 2. The galenic matrix 2 comprises a first reactant 1.1 and a second reactant 1.2. The galenic matrix is coated with a water-soluble layer 8. The galenic matrix further comprises a water-impeding substance 9 and a reaction enhancer 10.

FIG. 5 shows schematically a possible composition of the aqueous solution 3. The aqueous solution 3 contains a viscosity increasing substance 11 and a further viscosity increasing substance 11′. The aqueous solution 3 further contains a salt 12, a sugar 13, a sugar derivate 13′ and an acid 14. Moreover, the aqueous solution 3 contains an acid 15 which together with a reactant forms a poorly soluble salt. The aqueous solution 3 may be in form of a stable oil-water emulsion 3.1 and contain an emulsifying 16 agent and a stabilizing agent 17.

1-35. (canceled)

36. A method for controlled temperature change of substances, wherein the course of reaction of an endo- or exothermic reaction of one or several reactants in aqueous solution, which is in direct or indirect contact with the substances, is influenced using galenic methods, wherein at least one of said reactants is present in a solid form and is at least partly comprised in a galenic matrix, and wherein said galenic matrix is at least partly in a form selected from the group consisting of tablets, pellets, rods, and any combination thereof, and wherein said galenic matrix is differently strongly pressed in at least one of different regions and different parts.

37. A method for controlled temperature change of substances, wherein the course of reaction of an endo- or exothermic reaction of one or several reactants in aqueous solution, which is in direct or indirect contact with the substances, is influenced using galenic methods, wherein at least one of said reactants is present in a solid form and is at least partly comprised in a galenic matrix, and wherein said galenic matrix is at least partly in a form selected from the group consisting of granules and prills and any combination thereof, and wherein said reactant in the galenic matrix is differently strongly agglomerated in at least one of different regions and different parts, leading to different breaking strengths and packing densities of individual granules and prills.

38. The method according to claim 36, wherein the reactant is differently strongly pressed.

39. The method according to claim 36, wherein at least a part of said galenic matrix comprising the solid reactant is coated with a water-soluble layer.

40. The method according to claim 36, wherein said galenic matrix comprising said solid reactant comprises at least one of a water-impeding substance and a reaction enhancer.

41. The method according to claim 40, wherein said reaction enhancer is selected from the group consisting of calcium chloride, magnesium chloride, micro-crystalline cellulose (MCC), and sodium carboxyl methylcellulose.

42. The method according to claim 36, wherein one of said reactants is an alkaline earth metal oxide and is contacted with an aqueous solution comprising at least one viscosity-increasing substance.

43. The method according to claim 42, wherein said alkaline earth metal oxide is calcium oxide.

44. The method according to claim 42, wherein said aqueous solution comprises at least one of glycerol and polyethylene glycol (PEG) as a viscosity-increasing substance.

45. The method according to claim 44, wherein the portion of said glycerol is in the range from 0 to 60%.

46. The method according to claim 44, wherein the portion of said glycerol and said PEG is in the range from 0 to 10%.

47. The method according to claim 44, wherein said aqueous solution comprises at least one of a viscosity-increasing substance, a salt, a sugar, a sugar derivative and an acid.

48. The method according to claim 47, wherein said salt is selected from calcium chloride, sodium chloride, or magnesium chloride.

49. The method according to claim 47, wherein said sugar is selected from the group consisting of saccharose, glucose, lactose, caramel, and maltose.

50. The method according to claim 47, wherein said acid is at least one of citric acid and acetic acid, which together with said alkaline earth metal oxide forms a poorly soluble salt.

51. The method according to claim 42, wherein said aqueous solution is a stable oil-water emulsion with a low fat content.

52. The method according to claim 51, wherein for stabilizing said emulsion at least one of an emulsifying agent and a stabilizing agent is used.

53. The method according to claim 42, wherein said reaction is taking place in several successive phases.

54. The method according to claim 36, wherein the reaction is a reaction of a carbonate salt or bicarbonate salt with an acid and water.

55. The method according to claim 52, wherein the three components are present in the following portions of the total mass: carbonate salt or bicarbonate salt 15 to 50%, and water 15 to 50%.

56. The method according to claim 36, wherein the one or more reactants have an endothermic enthalpy of solution and are dissolved in the aqueous solution.

57. The method according to claim 56, wherein one reactant is urea, a further reactant is potassium nitrate and yet a further reactant is ammonium chloride.

58. The method according to claim 56, wherein one reactant is urea and a further reactant is ammonium nitrate.

59. A galenic matrix comprising at least one solid reactant, wherein said galenic matrix is in a form selected from the group consisting of tablets, pellets, rods, and any combination thereof, and wherein said galenic matrix comprising the solid reactant is differently strongly pressed in at least one of different regions and different parts.

60. The galenic matrix according to claim 59, wherein said galenic matrix comprises at least one of a reaction enhancer and a water-impeding substance.

61. The galenic matrix according to claim 59, wherein at least a part of said galenic matrix is coated with a water-soluble layer.

62. The galenic matrix according to claim 59, wherein said solid reactant is one of an alkaline earth metal oxide, a carbonate salt or a bicarbonate salt.

63. The galenic matrix according to claim 59, wherein it comprises as reactants urea, potassium nitrate and ammonium chloride.

64. The galenic matrix according to claim 59, wherein it comprises as reactants urea and ammonium nitrate.

65. The method according to claim 40, wherein said water-impeding substance is selected from a group consisting of magnesium stearate, calcium stearate, hydrogenated oil, polyvinylpyrrolidone, PEG 6000, and PEG 8000.

66. The method according to claim 47, wherein said further viscosity increasing substance is selected from a group consisting of xanthan, PEG, glycerol and any combination thereof.

67. The method according to claim 52, wherein said stabilizing agent is selected from the group comprising xanthan, guar gum and modified starch.
